(19) United States
(12) Patent Application Publication
(10) Pub. No.: US 2008/0102427 A1
(43) Pub. Date: May 1, 2008

(54) Method to increase likelihood of successful completion of degree program

(76) Inventor: Tod J. Nissle, Phoenix, AZ (US)

Correspondence Address: TOD R NISSLE, PO BOX 55630, PHOENIX, AZ, 85078, US

(21) Appl. No.: 11/588,819

(22) Filed: Oct. 27, 2006

(51) Int. Cl. G09B 3/00

(52) U.S. Cl. 434/322

(57) ABSTRACT

A method is provided for selecting a course in a degree program to increase the likelihood that an individual will successfully complete the degree program. The method includes the steps of identifying factors or criteria to evaluate the course, assigning plus and minus values to the criteria, defining minimum values necessary to be achieved to take the course, valuing the criteria, summing the criteria values, determining if the summed criteria values meet the defined minimum values, and, in the event the minimum values are not met, determining and identifying any ameliorating factors that justify taking the course.

More particularly, this invention pertains to a method and apparatus to facilitate successful completion of a high school or college class necessary to obtain a degree.

A student sometimes takes high school and college classes in which the student does poorly, but which are important because they provide credits in a degree program.

It would be highly desirable to provide a method and apparatus for the student to prepare for and select a class ahead of time to reduce the risk of faring poorly in the class.

Therefore, it is a principal object of the invention to provide an improved method and apparatus to select and prepare for an educational class in a degree program.

This, and other, further and more specific objects of the invention will be apparent to those skilled in the art from the following detailed description thereof, taken in conjunction with the drawings, in which:

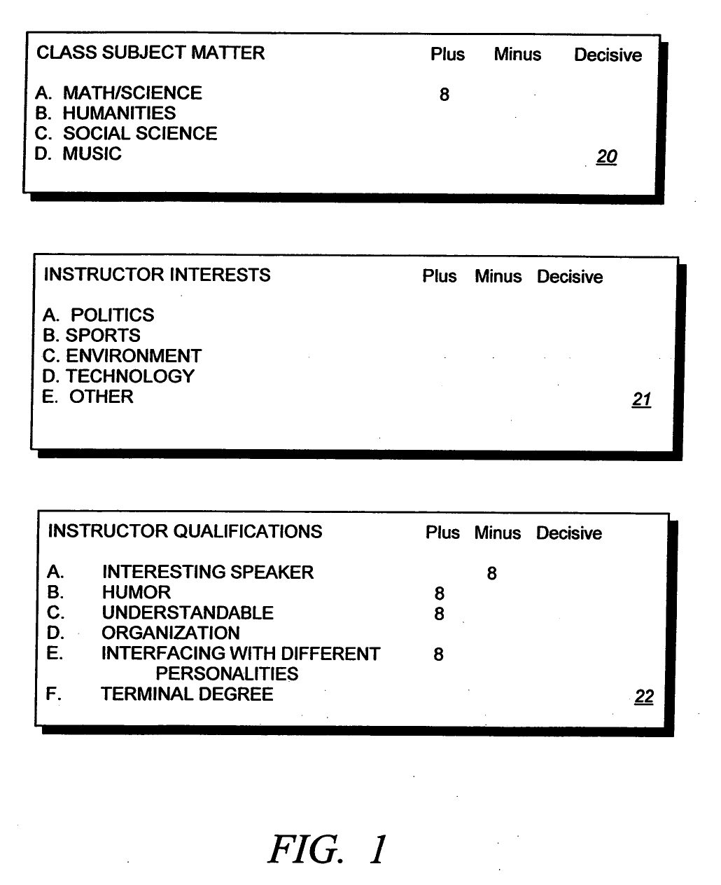

FIG. 1 is a block diagram illustrating in part the method of the invention;

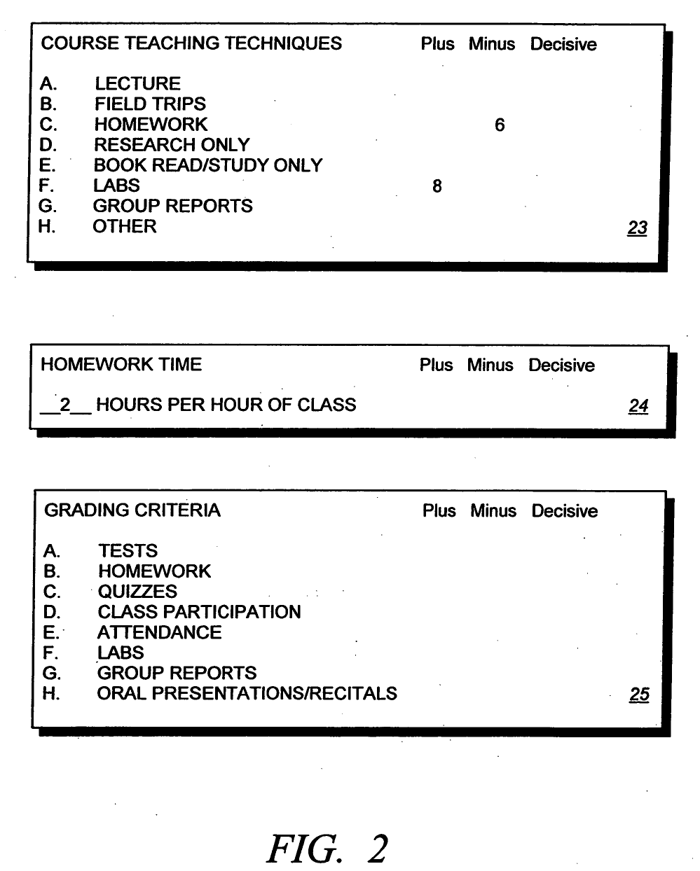

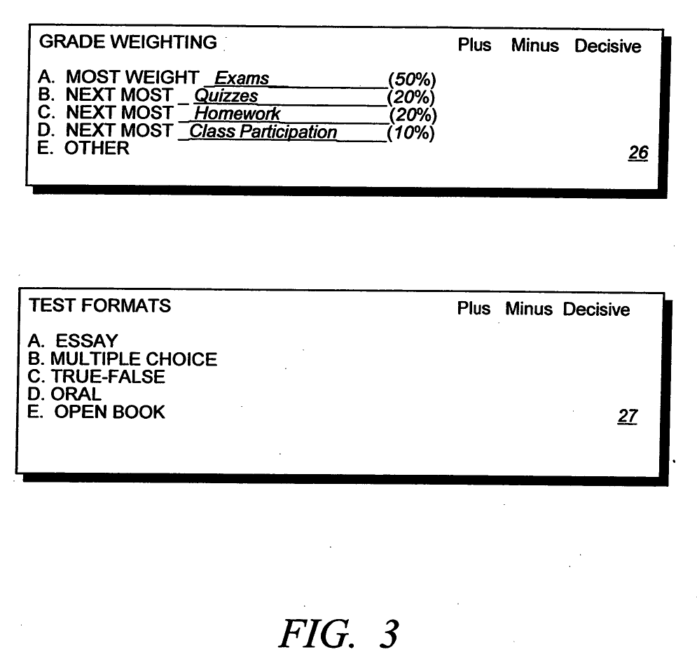

FIGS. 2 and 3 are block diagrams further illustrating in part the method of the invention; and,

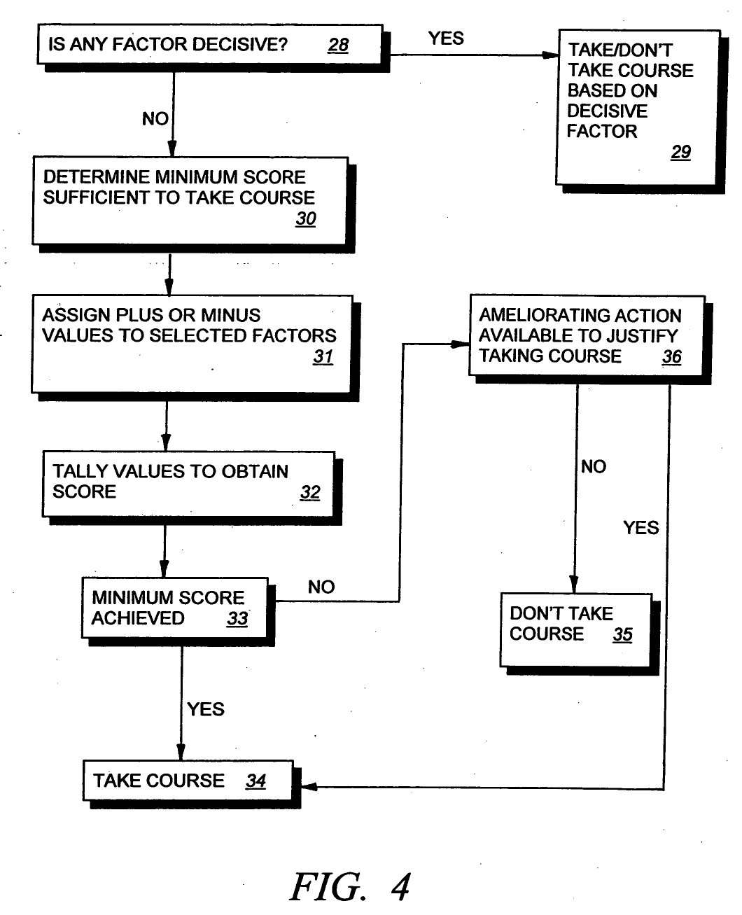

FIG. 4 is a block diagram further illustrating the method of the invention.

Briefly, in accordance with the invention, I provide a method to select an education course in a degree program to increase the likelihood of successful completion of the course. The method comprises the steps of listing factors including course subject matter, instructor profile, class study profile, grading criteria, homework time commitment, grading weight, and testing methodology; assigning a value to each of the factors; determining a minimum score to take the course; totaling the value of the factors to obtain a total score; determining if the total score is at least equal to the minimum score; and, taking the course if the total score is at least equal to the minimum score.

Turning now to the drawings, in which like reference characters refer to corresponding elements throughout the several views, and which illustrate the presently preferred embodiments of the invention, FIG. 1 illustrates factors to be considered in evaluating whether to commit to taking a course in a degree program. One group of factors comprises class subject matter 20 including math/science, humanities, social science, and music, or, any other class subject matter selected as a factor in class subject matter. Each factor is identified by a student as a plus on a scale of 1 to 10 (with 1 being somewhat positive and 10 being extremely positive), a minus on a scale of one to ten (with 1 being somewhat negative and 10 being extremely negative), or decisive. A factor is decisive if it alone determines for a student whether the student will, or won't take the course. A factor is a minus if it suggests to the student that the student should not take the course. A factor is positive if it suggest to the student that the student should take the course.

A second group of factors comprises instructor interests 21 which comprises politics, sports, environment, technology, or other factor(s).

A third group of factors comprises instructor qualifications 22 including whether the instructor is an interesting speaker, has humor, is understandable, has organization, can interface with different student personalities, and has a terminal degree.

FIG. 2 illustrates additional factors including course teaching techniques 23 including lecture, field trips, homework, research only, book read and study only, labs, group reports, and other factor(s).

Homework time 24 is an additional factor.

Grading criteria 25 includes the factors of tests, homework, quizzes, class participation, attendance, labs, group reports, and oral presentations/recitals.

FIG. 3 illustrates two additional groups of factors including grade weighting 26 with factors of most weight, next most, next most, next most, and other. Test formats 27 is the other group of factors illustrated in FIG. 3, and includes essay, multiple choice, true-false, oral, and open book.

A review of FIGS. 1 indicates that when the student reviewed the prospective course:

1. The class subject matter 20 (FIG. 1) was a math or science course and this was, from the student's perspective, a significant plus worth 8 points on a scale of 1 to 10. The student did not consider any of the factors in class subject matter 20 to be decisive.

2. The student did not consider any of the instructor interests 21 (FIG. 1) to be plus or minus or decisive.

3. In instructor qualifications 22 (FIG. 1), the instructor was not, from the student's perspective, an interesting speaker, and this was a significant minus worth eight points on a scale of one to ten. On the other hand, the instructor has a sense of humor, is understandable, and is adept at interfacing with different student personalities. Each of these factors was a significant plus worth eight points on a scale of one to ten. None of the remaining factors was considered to be a plus or a minus. None of the factors in instructor qualifications 22 was considered to be decisive.

4. In course teaching techniques 23 (FIG. 2), homework was considered a minus factor valued at six points on a scale of one to ten. The use of labs in the class was considered a significant plus worth eight points on a scale of one to ten. None of the remaining factors was considered to be a plus or a minus. None of the factors in course teaching techniques 23 was considered to be decisive.

5. In homework time 24 (FIG. 2), homework of two hours per hour of class was not considered to be a plus or a minus or to be decisive.

6. In grading criteria 25 (FIG. 2), the first four criteria listed (tests, homework, quizzes, and class participation) were identified as the only criteria used to assign grades. None of the factors or criteria were considered to be a plus or a minus or to be decisive.

7. In grade weighting 26 (FIG. 3), the four grading criteria or factors assigned most weight were listed, and included exams (50% of grade), quizzes (20% of grade), homework (20% of grade), and class participation (10% of grade). None of the factors was deemed a plus or minus or decisive.

8. In test formats 27 (FIG. 3), it was determined that essay, multiple choice, and true-false test formats were the only formats utilized. None of these formats was deemed to be a plus or minus or to be decisive.

FIG. 4 sets forth the remainder of the process of the invention after the factors in FIGS. 1 and 2 are selected. The first step 28 is to determine if any factor is decisive. If a factor is decisive then it indicates that a student will, or won't take the course 29 and that ends the process. If, alternatively, none of the factors is decisive, then a minimum score is determined and selected 30. The minimum score indicates how many positive points, or negative points, are necessary or permitted before a student takes a course. For sake of discussion, it is assumed that forty (40) positive points and no more than twenty (20) negative points are necessary before a student takes a course. The point values selected can vary as desired.

After the minimum scores are determined, plus and minus values are, for the class being evaluated, assigned to each factor 31 in the manner described above. The points are totaled. The points are tallied 32. In FIGS. 1 to 3, the positive points total forty, and the minus points total fourteen. These points values meet the assigned necessary point values for the student to take the course, and the minimum score is achieved 33. The student takes the course 34. If the minimum score had not been achieved, the student would determine if there is an ameliorating action available to justify taking the course 36. Such an ameliorating action could be taking the course from a different professor, taking another course first to prepare for the course being evaluated, obtaining permission for different grading criteria to be utilized, etc. If such an ameliorating action is available and is sufficient to justify to the student taking the course, the student takes the course 34. If the ameliorating action is not available, the student does not take the course 35.

Having described the invention in such terms as to enable those of skill in the art to understand and practice it, and having described the presently preferred embodiments thereof, I claim:

1. A method to select an education course in a degree program to increase the likelihood of successful completion of the course, comprising
(a) listing factors including course subject matter, instructor profile, class study profile, grading criteria, homework time commitment, grading weight, and testing methodology;
(b) assigning a value to each of said factors;
(c) determining a minimum score to take the course;
(d) totaling the value of said factors to obtain a total score;
(e) determining if said total score is at least equal to said minimum score; and,
(f) taking the course if said total score is at least equal to said minimum score.
